(19) United States
(12) Patent Application Publication
(10) Pub. No.: US 2007/0192573 A1
(43) Pub. Date: Aug. 16, 2007

(54) Device, system and method of handling FXCH instructions

(76) Inventors: Guillermo Savransky, Neve Shaanan (IL); Yuval Bustan, Moshav Mismeret (IL); Asi Sapir, Kiriyat Motzkin (IL)

Correspondence Address: PEARL COHEN ZEDEK LATZER, LLP, 1500 BROADWAY, 12TH FLOOR, NEW YORK, NY, 10036, US

(21) Appl. No.: 11/354,872

(22) Filed: Feb. 16, 2006

(51) Int. Cl. G06F 9/44

(52) U.S. Cl. 712/222

(57) ABSTRACT

Some embodiments of the invention provide devices, systems and methods of handling FXCH instructions data validity. For example, an apparatus in accordance with an embodiment of the invention includes a real register file unit able to perform a floating point exchange micro-instruction, by modifying an operand of a floating point micro-instruction that attempts to access a floating point register of said real register file unit, if said operand requires modification based on the floating point exchange micro-instruction.

### BACKGROUND OF THE INVENTION

A processor core may include one or more execution units (EUs) able to execute micro-operations (“u-ops”), for example, utilizing an out-of-order (OOO) subsystem. For example, an instructions decoder (ID) may decode a macro-instruction, intended for execution by the processor, into micro-operations. A reservation station (RS) may dispatch the micro-operations to the EUs for execution.

Some instruction set architectures (ISAs) utilize multiple floating point (FP) registers implemented using a register stack, e.g., having eight FP registers. An instruction to exchange content of FP registers (FXCH) may be used to move data from a certain FP register to the top-of-stack (TOS) position; once moved, the data may be used in a subsequent operation, which may reference the TOS register. Various instructions require that a data item be moved to the TOS register before an operation on that data item may be performed.

Some methods of handling a FXCH instruction may utilize a register renaming mechanism to map logical registers onto a set of physical registers, e.g., using a register alias table (RAT) unit. For example, a FXCH instruction may require to exchange the content of the third register in the register stack (i.e., ST(3)) with the content of the TOS register (i.e., ST(0)). Instead of swapping between the content of the third register and the content of the TOS register, the RAT may swap between two respective pointers that point to these two registers. The FXCH instruction may thus be marked as “complete”in a reorder buffer (ROB) as soon as the ROB receives the FXCH instruction, thereby avoiding overhead by the RS and the EUs.

However, since the RAT executes the FXCH instruction internally by swapping between pointers, only the RAT may track the mapping between the logical registers and the physical registers, e.g., using one or more internal arrays. For example, the RAT may utilize an internal secondary array of pointers to execute the FXCH instruction, and upon retirement of the FXCH instruction, the RAT may copy the content of the secondary array to a primary array of pointers of the RAT. Other components, for example, a real register file (RRF) may not track the internal mapping of the FP registers, which may be handled exclusively by the RAT.

The OOO sub-system may execute instructions at a non-sequential order, e.g., utilizing multiple branches of speculative execution. Upon a mis-prediction, for example, resulting from a “cache miss”, a recovery process may be performed by the RAT, e.g., to correct speculative renaming operations that turned out to be incorrect. Unfortunately, the recovery process may involve overhead, e.g., power overhead and/or time overhead.

### BRIEF DESCRIPTION OF THE DRAWINGS

The subject matter regarded as the invention is particularly pointed out and distinctly claimed in the concluding portion of the specification. The invention, however, both as to organization and method of operation, together with features and advantages thereof, may best be understood by reference to the following detailed description when read with the accompanied drawings in which:

FIG. 1 is a schematic block diagram illustration of a computing system able to handle FXCH instructions in accordance with an embodiment of the invention;

FIG. 2 is a schematic block diagram illustration of a computing system able to handle FXCH instructions in accordance with another embodiment of the invention;

FIG. 3 is a schematic block diagram illustration of a processor core able to handle FXCH instructions in accordance with an embodiment of the invention;

FIG. 4 is a schematic block diagram illustration of a RRF allocation stage functionality in accordance with an embodiment of the invention;

FIG. 5 is a schematic block diagram illustration of a RRF sub-circuit able to perform an allocation stage in accordance with an embodiment of the invention;

FIG. 6 is a schematic block diagram illustration of a RRF sub-circuit able to perform a read stage in accordance with an embodiment of the invention;

FIG. 7 is a schematic block diagram illustration of a RRF sub-circuit able to perform a retirement stage in accordance with an embodiment of the invention;

FIG. 8 is a schematic block diagram illustration of a RRF retirement stage functionality in accordance with an embodiment of the invention;

FIG. 9 is a schematic block diagram illustration of a RRF sub-circuit able to handle retirement of FP micro-operations in accordance with an embodiment of the invention;

FIG. 10 is a schematic block diagram illustration of a RRF recovery stage functionality in accordance with an embodiment of the invention; and

FIG. 11 is a schematic flow-chart of a method of handling FXCH instructions in accordance with an embodiment of the invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

In the following detailed description, numerous specific details are set forth in order to provide a thorough understanding of the invention. However, it will be understood by those of ordinary skill in the art that the invention may be practiced without these specific details. In other instances, well-known methods, procedures, components, units and/or circuits have not been described in detail so as not to obscure the invention.

Embodiments of the invention may be used in a variety of applications. Although embodiments of the invention are not limited in this regard, embodiments of the invention may be used in conjunction with many apparatuses, for example, a computer, a computing platform, a personal computer, a desktop computer, a mobile computer, a laptop computer, a notebook computer, a personal digital assistant (PDA) device, a tablet computer, a server computer, a network, a wireless device, a wireless station, a wireless communication device, or the like. Embodiments of the invention may be used in various other apparatuses, devices, systems and/or networks.

Although embodiments of the invention are not limited in this regard, discussions utilizing terms such as, for example, “processing,” “computing,” “calculating,” “determining,”“establishing”, “analyzing”, “checking”, or the like, may refer to operation(s) and/or process(es) of a computer, a computing platform, a computing system, or other electronic computing device, that manipulate and/or transform data represented as physical (e.g., electronic) quantities within the computer's registers and/or memories into other data similarly represented as physical quantities within the computer's registers and/or memories or other information storage medium that may store instructions to perform operations and/or processes.

Although embodiments of the invention are not limited in this regard, the terms “plurality” and/or “a plurality” as used herein may include, for example, “multiple” or “two or more”. The terms “plurality” and/or “a plurality” may be used herein describe two or more components, devices, elements, parameters, or the like. For example, a plurality of elements may include two or more elements.

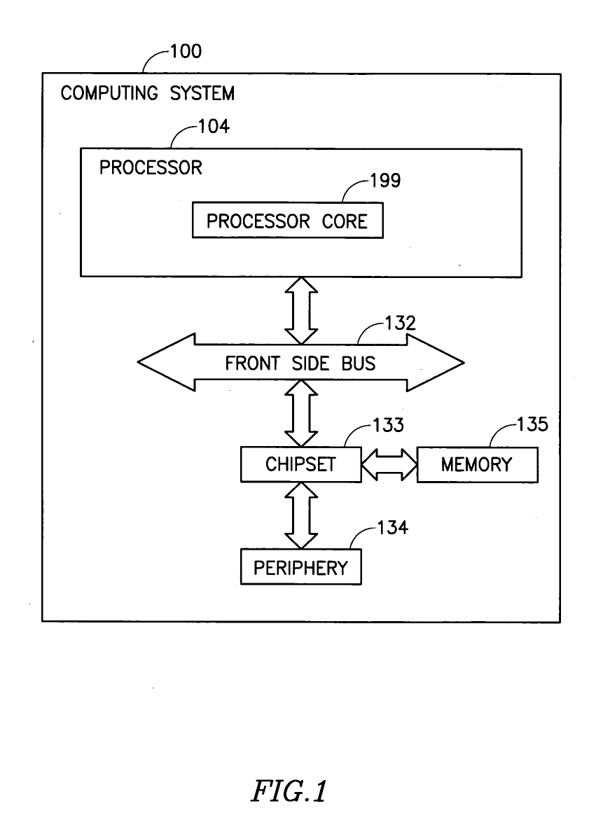

FIG. 1 schematically illustrates a computing system 100 able to handle FXCH instructions in accordance with some embodiments of the invention. Computing system 100 may include or may be, for example, a computing platform, a processing platform, a personal computer, a desktop computer, a mobile computer, a laptop computer, a notebook computer, a terminal, a workstation, a server computer, a personal digital assistant (PDA) device, a tablet computer, a network device, a cellular phone, or other suitable computing and/or processing and/or communication device.

Computing system 100 may include a processor 104, for example, a central processing unit (CPU), a digital signal processor (DSP), a microprocessor, a host processor, a controller, a plurality of processors or controllers, a chip, a microchip, or any other suitable multi-purpose or specific processor or controller. Processor 104 may include one or more processor cores, for example, a processor core 199. Processor core 199 may optionally include, for example, an out-of-order (OOO) module or subsystem, an execution block or subsystem, one or more execution units (EUs), one or more adders, multipliers, shifters, logic elements, combination logic elements, AND gates, OR gates, NOT gates, XOR gates, switching elements, multiplexers, sequential logic elements, flip-flops, latches, transistors, circuits, sub-circuits, and/or other suitable components. In some embodiments, processor core 199 may handle FXCH instructions as described in detail herein.

Computing system 100 may further include a shared bus, for example, a front side bus (FSB) 132. For example, FSB 132 may be a CPU data bus able to carry information between processor 104 and one or more other components of computing system 100.

In some embodiments, for example, FSB 132 may connect between processor 104 and a chipset 133. The chipset 133 may include, for example, one or more motherboard chips, e.g., a “northbridge” and a “southbridge”, and/or a firmware hub. Chipset 133 may optionally include connection points, for example, to allow connection(s) with additional buses and/or components of computing system 100.

Computing system 100 may further include one or more peripheries 134, e.g., connected to chipset 133. For example, periphery 134 may include an input unit, e.g., a keyboard, a keypad, a mouse, a touch-pad, a joystick, a microphone, or other suitable pointing device or input device; and/or an output unit, e.g., a cathode ray tube (CRT) monitor, a liquid crystal display (LCD) monitor, a plasma monitor, other suitable monitor or display unit, a speaker, or the like; and/or a storage unit, e.g., a hard disk drive, a floppy disk drive, a compact disk (CD) drive, a CD-recordable (CD-R) drive, or other suitable removable and/or fixed storage unit. In some embodiments, for example, the aforementioned output devices may be coupled to chipset 133, e.g., in the case of a computing system 100 utilizing a firmware hub.

Computing system 100 may further include a memory 135, e.g., a system memory connected to chipset 133 via a memory bus 136. Memory 135 may include, for example, a random access memory (RAM), a read only memory (ROM), a dynamic RAM (DRAM), a synchronous DRAM (SD-RAM), a flash memory, a volatile memory, a non-volatile memory, a cache memory, a buffer, a short term memory unit, a long term memory unit, or other suitable memory units or storage units. Computing system 100 may optionally include other suitable hardware components and/or software components.

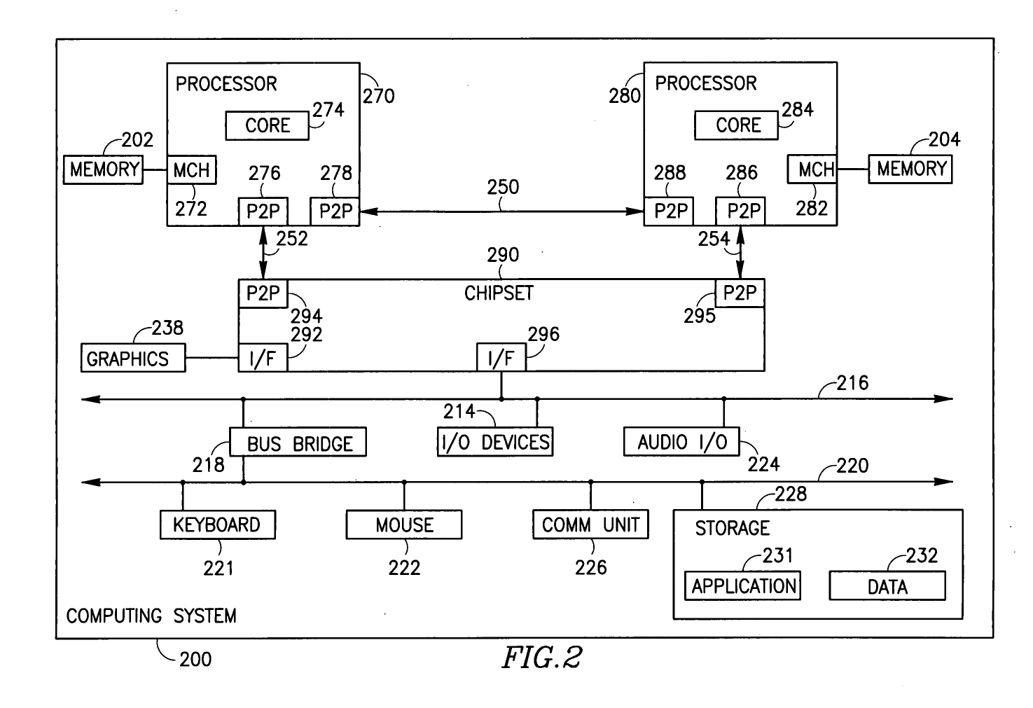

FIG. 2 schematically illustrates a computing system 200 able to handle FXCH instructions in accordance with some embodiments of the invention. Computing system 200 may include or may be, for example, a computing platform, a processing platform, a personal computer, a desktop computer, a mobile computer, a laptop computer, a notebook computer, a terminal, a workstation, a server computer, a personal digital assistant (PDA) device, a tablet computer, a network device, a cellular phone, or other suitable computing and/or processing and/or communication device.

Computing system 200 may include, for example, a point-to-point busing scheme having one or more processors, e.g., processors 270 and 280; memory units, e.g., memory units 202 and 204; and/or one or more input/output (I/O) devices, e.g., I/O device(s) 214, which may be interconnected by one or more point-to-point interfaces.

Processors 270 and/or 280 may include, for example, processor cores 274 and 284, respectively. In some embodiments, processor cores 274 and/or 284 may handle FXCH instructions as described in detail herein.

Processors 270 and 280 may further include local memory channel hubs (MCH) 272 and 282, respectively, for example, to connect processors 270 and 280 with memory units 202 and 204, respectively. Processors 270 and 280 may exchange data via a point-to-point interface 250, e.g., using point-to-point interface circuits 278 and 288, respectively.

Processors 270 and 280 may exchange data with a chipset 290 via point-to-point interfaces 252 and 254, respectively, for example, using point-to-point interface circuits 276, 294, 286, and 295. Chipset 290 may exchange data with a high-performance graphics circuit 238, for example, via a high-performance graphics interface 292. Chipset 290 may further exchange data with a bus 216, for example, via a bus interface 296. One or more components may be connected to bus 216, for example, an audio I/O unit 224, and one or more input/output devices 214, e.g., graphics controllers, video controllers, networking controllers, or other suitable components.

Computing system 200 may further include a bus bridge 218, for example, to allow-data exchange between bus 216 and a bus 220. For example, bus 220 may be a small computer system interface (SCSI) bus, an integrated drive electronics (IDE) bus, a universal serial bus (USB), or the like. Optionally, additional I/O devices may be connected to bus 220. For example, computing system 200 may. further include, a keyboard 221, a mouse 222, a communications unit 226 (e.g., a wired modem, a wireless modem, a network interface, or the like), a storage device 228 (e.g., to store a software application 231 and/or data 232), or the like.

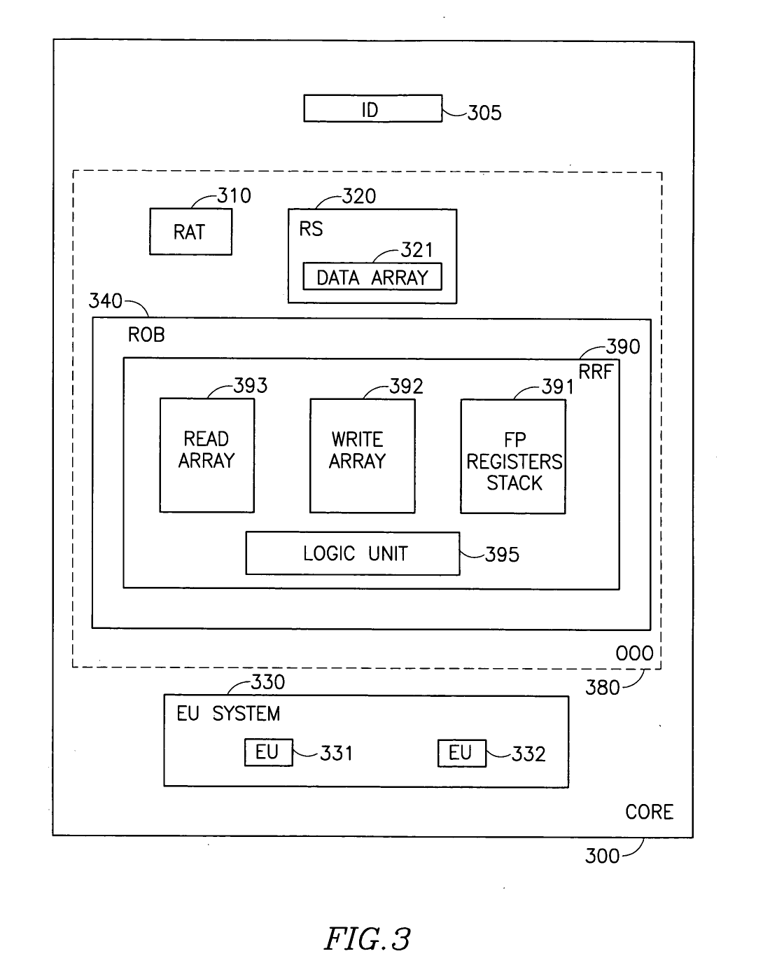

FIG. 3 schematically illustrates a processor core 300 able to handle FXCH instructions in accordance with some embodiments of the invention. Processor core 300 may be an example of processor core 199 of FIG. 1, an example of processor core 274 of FIG. 2, an example of processor core 284 of FIG. 2, or a processor core utilized in conjunction with other suitable processors or processing platforms.

Processor core 300 may receive, for example, from a memory unit, e.g., from memory unit 135 of FIG. 1 or from memory units 202 or 204 of FIG. 2, one or more macro-instructions intended for execution. Processor core 300 may execute the macro-instructions substantially in program order, for example, substantially in the same order the macro-instructions are received by processor core 300. Alternatively, processor core 300 may execute the macro-instructions out of order, for example, in an order different than the order the macro-instructions are received by processor core 300. In some embodiments, processor core 300 may produce results of the macro-instructions in substantially the same order the macro-instructions are received by processor core 300.

Processor core 300 may include, for example, a macro instruction decoder (ID) 305, a register alias table (RAT) 310, a reservation station (RS) 320, an execution system 330, and a reorder buffer (ROB) 340 including a real register file (RRF) 390. In some embodiments, one or more components of processor core 300, for example, RAT 310, RS 320, ROB 340 and RRF 390, may optionally be implemented using an out-of-order (OOO) subsystem 380. Processor core 300 and/or OOO subsystem 380 may include other suitable hardware components and/or software components in addition to, or instead of, those shown.

Execution system 330 may include one or more execution units (EUs), for example, an EU 331 and an EU 332.

The ID 305 may receive a macro-instruction intended for execution by processor core 300. The ID 305 may decode the macro-instruction into one or more micro-operations, for example, depending upon a type of the macro-instruction. In some embodiments, for example, the ID 305 may decode the macro-instruction into a plurality of micro-operations of different types, e.g., a first micro-operation of a first type intended for execution by EU 331, and a second micro-operation of a second type intended for execution by EU 332. A micro-operation may be executed by the EU 331 or 332 with relation to one or more source operands, for example, source operands which may be received by RS 320, e.g., from a front-end of processor core 300, from ROB 340, or from execution system 330.

The ID 305 may generate, for example, an operation code (“op-code”) representing the type of operation intended to be preformed on the source operands. Optionally, the ID 305 may further generate signals indicating a width of the source operands, and/or signals indicating the type of EU intended to execute the micro-operation.

The RAT 310 may receive the signals generated by ID 305, for example, substantially in the same order the micro-operations were generated by ID 305. The RAT 310 may determine which of the EUs of execution system 330 is to execute a micro-operation corresponding to a generated op-code. In some embodiments, RAT 310 may provide to RS 320 and to ROB 340 corresponding to the op-code and to the source operand width. The RAT 310 may further provide to RS 320 signals indicating a selected EU intended to execute the micro-operation.

In some embodiments, RS 320 may store and/or handle more than one micro-operation at a time. For example, RS 320 may include a data array 321 able to store one or more source operands corresponding to the one or more micro-operations generated by ID 305. The RS 320 may controllably provide or “dispatch” to an EU of execution system 330, e.g., to EU 331, an op-code and/or one or more source operands corresponding to a micro-operation.

Upon execution of the micro-operation by the execution system 330, ROB 340 may receive reorder execution results from the execution system 350, e.g., optionally according to the original order of micro-operations generated by ID 305. The ROB 340 may output the execution results, for example, to a retired register file associated with processor core 300, and/or to RS 320.

RRF 390 may include, for example, one or more FP registers, e.g., eight FP registers, which may be implemented using a FP registers stack 391. RRF 390 may further include a RRF write array 392 and a RRF read array 393, which may store pointers to FP registers in the stack 391. RRF may additionally include a RRF logic unit 395, e.g., able to modify the content of RRF write array 392 and/or RRF read array 393.

In some embodiments, when an instruction to exchange content of FP registers (FXCH) is received, the RAT 310 may not modify FP registers mapping which may be stored in RAT 310, and/or the RAT 310 may maintain unmodified the current mapping of FP registers which maybe stored in the RAT 310. The FXCH instruction may be handled substantially exclusively by the RRF 390, e.g., utilizing the RRF logic unit 395, and without using RAT 310 decoding. For example, RAT 310 may operate in relation to the FP registers in a way similar to the way RAT 310 operates in relation to integer registers; and the RRF 390 may handle the FXCH instruction internally. It is noted that in some embodiments, the RAT 310 may modify FP register(s) mapping when a FXCH instruction is received, e.g., if one or more of the operands of the FXCH instruction relates to the ROB 340 and not to the RRF 390.

For example, RRF read array 393 and/or RRF write array 392 may be used to map the FP registers of stack 391. Upon receiving a FXCH instruction, the RRF logic unit 395 may modify the content of one or more records stored in RRF read array 393 and/or RRF write array 392 to reflect the FXCH instruction. For example, the RRF logic unit 395 may swap between the content of a first record in RRF read array 393 and the content of a second record in RRF read array 393; and/or may swap between the content of a first record in RRF write array 392 and the content of a second record in RRF write array 392. In some embodiments, for example, records in the RRF read array 393 may be modified and/or swapped upon allocation of a FXCH instruction, whereas records in the RRF write array 392 may be modified and/or swapped upon retirement of a FXCH instruction.

RRF 390 and/or RRF logic unit 395 may optionally include one or more sub-circuits to handle various operations or stages related to FXCH instructions. For example, RRF 390 and/or RRF logic unit 395 may include sub-circuit(s) to handle allocation stages, sub-circuit(s) to handle read stages, sub-circuit(s) to handle write stages, sub-circuit(s) to handle retirement of FXCH instructions, sub-circuit(s) to handle instructions pending for retirement in a retirement window, or the like.

In some embodiments, for example, FP registers stack 391 may include a certain number of FP registers, denoted N; the RRF write array 392 may include N entries or records corresponding to the N FP registers, respectively; and the RRF read array 393 may include N entries or records corresponding to the N FP registers, respectively. Optionally, RRF 390 and/or RRF logic unit 395 may include N respective sub-circuits to handle allocation stages, N respective sub-circuits to handle read stages, N respective sub-circuits to handle write stages, N respective sub-circuits to handle retirement stages, or the like.

In some embodiments, the RRF 390 may receive a FXCH micro-instruction decoded by the ID 305 and unmodified-by the RAT 310. The RRF read array 393 may store logical pointers for reading from physical FP registers of the FP registers stack 391; and the RRF write array 392 may store logical pointers for writing to the physical FP registers of the FP registers stack 391. In some embodiments, for example, the RRF read array 393 and/or the RRF write array 392 may be internal to RRF 390, may be integrated within RRF 390, may be operatively associated or coupled to RRF 390, may be hard-wired within RRF 390, may be hard-wired to connect with RRF 390, may be non-external to RRF 390, may be external to RAT 310, or the like.

In some embodiments, RRF 390 may be able to handle or perform a FXCH micro-instruction. For example, the RRF logic unit 395 may determine whether a received micro-instruction is a FXCH micro-instruction, e.g., based on the op-code of the received micro-instruction. The RRF 390 may modify an operand of a FP micro-instruction that attempts to access a FP register of the RRF 390, if the operand requires modification based on the FXCH micro-instruction.

In some embodiments, for example, the RRF logic unit 395 may determine whether a received micro-instruction is a FXCH micro-instruction that affects an access of another FP micro-instruction to a FP register of the RRF 390. For example, the RRF logic unit 395 may modify a content of one or more entries of the RRF read array 393 if the FXCH micro-instruction affects a subsequent FP micro-instruction that attempts to perform a read access to the FP register of the RRF 390. Similarly, the RRF logic unit 395 may modify a content of one or more entries of the RRF write array 392 if the received FXCH micro-instruction affects a subsequent FP micro-instruction that attempts a write access to the FP register of the RRF 390.

In some embodiments, for example, the RRF logic unit 395 may swap, in response to the FXCH micro-instruction, between a content of a first entry of the RRF read array 393 and a content of a second entry of the RRF read array 393; and/or to swap, in response to the FXCH. micro-instruction, between a content of a first entry of the RRF write array 392 and a content of a second entry of the RRF write array 392.

In some embodiments, for example, upon recovery, the RRF logic unit 395 may copy the contents of the entries of the RRF write array 392 into the corresponding entries of the RRF read array 393, respectively.

In some embodiments, the RRF logic unit 395 may exclusively place a single FXCH micro-instruction within a retirement window associated with a single clock cycle; e.g., such that the retirement window of a single clock cycle may include not more than one FXCH micro-instruction, and may optionally include other (e.g., non-FXCH) micro-instructions. For example, the RRF logic unit 395 may place the FXCH micro-instruction in the first retirement slot of a retirement window associated with a single clock cycle.

In some embodiments, a FXCH instruction as originally decoded by the ID 305 (an “original” or “raw” FXCH micro-instruction), and a FP micro-instruction as originally decoded by the ID 305 (an “original” or “raw” FP micro-instruction), may be maintained substantially unmodified by the RAT 310. For example, the RAT 310 may transfer to the RRF 390 “raw” FXCH micro-instructions and/or FP micro-instruction(s), since the RRF 390 may handle internally the FXCH micro-instruction and the other FP micro-instruction(s) which may be affected by the FXCH micro-instruction.

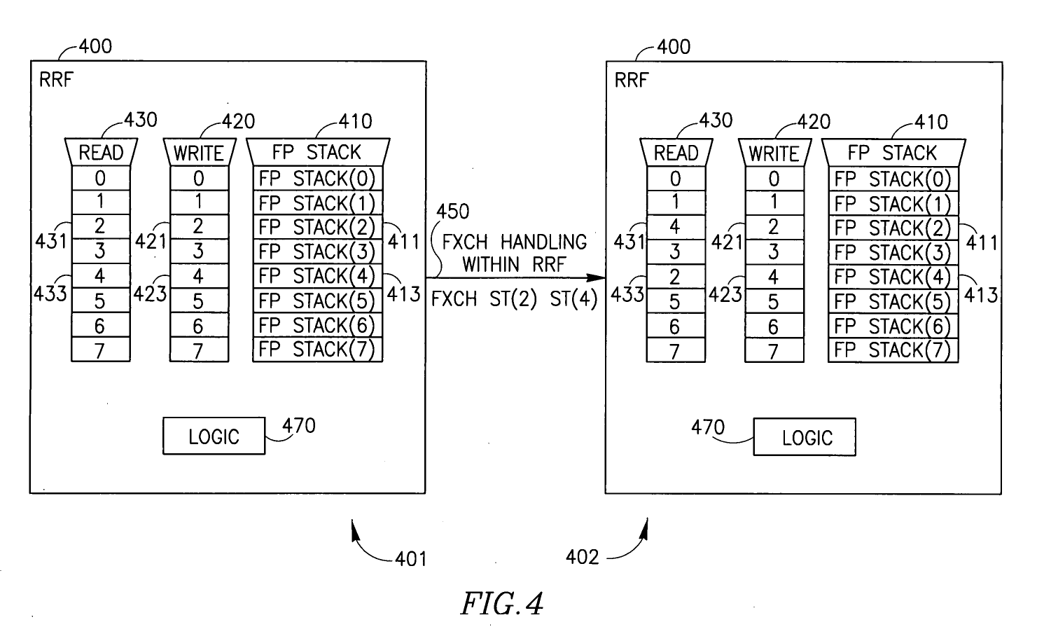

FIG. 4 schematically illustrates a RRF 400 allocation stage functionality in accordance with some embodiments of the invention. Portion 401 demonstrates the content of RRF 400 prior to handling a FXCH instruction, and portion 402 demonstrates the content of RRF 400 subsequent to handling the FXCH instruction. The RRF 400 may include, for example, a FP registers stack 410, e.g., having eight FP registers; a RRF write array 420, e.g., having eight records corresponding to the eight FP registers of stack 410; a RRF read array 430, e.g., having eight records corresponding to the eight FP registers of stack 410; and a RRF logic unit 470.

As indicated at portion 401, prior to handling a FXCH instruction, the content of a record 431 in RRF read array 430 may point to a FP register 411, and the content of a record 421 in RRF write array 420 may point to FP register 411. Similarly, the content of a record 433 in RRF read array 430 may point to a FP register 413, and the content of a record 423 in RRF write array 420 may point to FP register 413.

As indicated by arrow 450, the FXCH instruction may be handled internally by the RRF 400, e.g., utilizing the RRF logic unit 470 instead of by an external component, e.g., a RAT unit. For example, the FXCH instruction may require swapping between the content of FP register 411 and the content of FP register 413.

As indicated at portion 402, upon handling the FXCH instruction, the content of record 431 may be swapped with the content of record 433. This may be performed, for example, utilizing RRF logic unit 470 of the RRF 400. For example, subsequent to executing the FXCH instruction, the content of record 431 in RRF read array 430 may point to FP register 413, instead of pointing to FP register 411; and the content of record 433 in RRF read array 430 may point to FP register 411, instead of pointing to FP register 413.

In some embodiments, for example, the FXCH instruction may affect only subsequent instructions that may attempt to read from FP registers, and may not affect subsequent instructions that may attempt to write to the FP registers, or vice versa. Accordingly, for example, the content of records 431 and 433 of RRF read array 430 may be swapped, whereas the content of records 421 and 423 of RRF write array 420 may be maintained unmodified (e.g., not swapped), or vice versa, respectively.

In the demonstrative example shown in portion 402 of FIG. 4, a FXCH instruction, e.g., the instruction “FXCH ST(2) ST(4)” was allocated but did not yet retire. The RRF read array 430 may be used for address decoding upon allocation; for example, upon a read access intended to read the content of FP register 413, the RF 400 may access and send out instead the content of FP register 411, since records 431 and 433 of RRF read array 430 indicate the content of FP registers 413 and 411 are swapped. A similar address decoding may be performed using the RRF write array 420, for example, upon retirement of a FXCH instruction.

In some embodiments, the demonstrative example shown in portion 401 of FIG. 4 may be utilized upon a reset. For example, when a reset is asserted, the content of RRF read array 430 and the content of RRF write array 420 may be reset to point to the physical location of the FP registers of stack 410, e.g., as shown in portion 401 of FIG. 4.

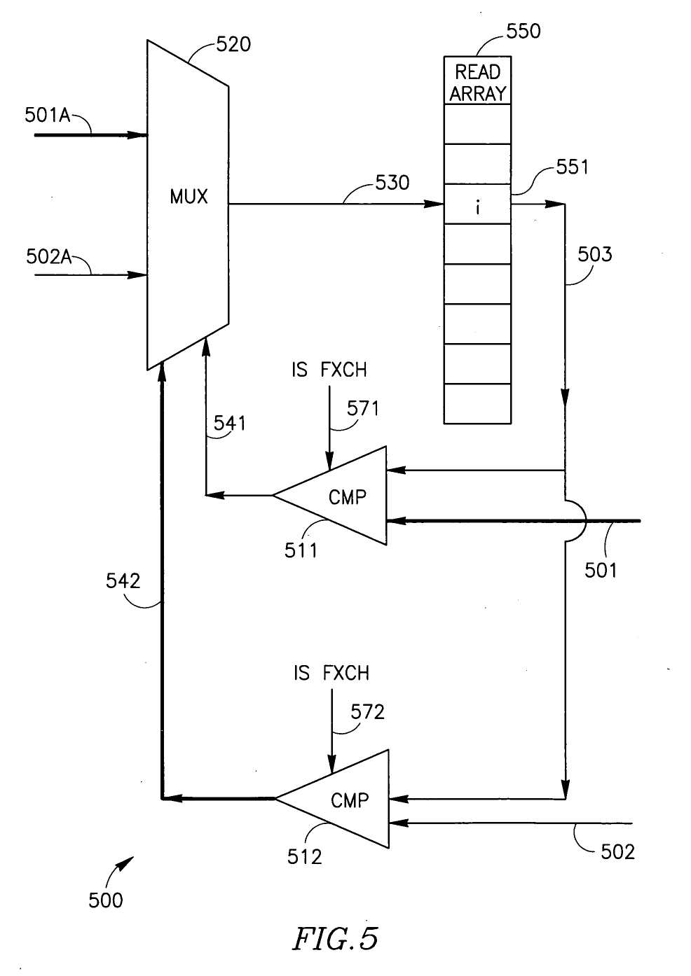

FIG. 5 schematically illustrates a RRF sub-circuit 500 able to perform an allocation stage in accordance with some embodiments of the invention. Sub-circuit 500 may be, for example, part of RRF 300 of FIG. 1, part of RRF 400 of FIG. 4, or part of other RRF units.

In some embodiments, upon allocation, the ROB may receive a logical source and a logical destination, and the RRF may swap between these two values in a RRF read array 550. For example, the RRF may compare the value of the logical source and the value of an entry 551 of the RRF read array 550; if the values are equal, and the received instruction is a FXCH instruction, then the RRF may write the value of the logical destination into the entry 551 of the RRF read array 550. Similarly, for example, the RRF may compare the value of the logical destination and the value of entry 551 of the RRF read array 550; if the values are equal, and the received instruction is a FXCH instruction, then the RRF may write the value of the logical source into entry 551 of the RRF read array 550.

In some embodiments, the RRF may include multiple sub-circuits similar to sub-circuit 500 which may correspond to multiple entries in the RRF read array 550, respectively. For example, the RRF may include a first sub-circuit 500 associated with a first entry in the RRF read array 550, a second sub-circuit 500 associated with a second entry in the RRF read array 550, etc.

In some embodiments, an instruction having one or more operands, for example, a logical source 501 and a logical destination 502, may be received by the RRF sub-circuit 500. In one embodiment, for example, an instruction received by sub-circuit 500 may be “FXCH ST(3) ST(5)”, the value of the logical source 501 may be 3, and the value of the logical destination 501 may be 5.

In some embodiments, sub-circuit 500 may be one of multiple sub-circuits that correspond to entries in RRF read array 550, respectively. For example, sub-circuit 500 may be associated with an entry 551 in the RRF read array 550, and entry 551 may store an index value which may be denoted i, the index value pointing to a FP register of the RRF. The index value i stored in entry 551 may be represented or indicated using a signal 503.

A comparator 511 may compare between the value of the logical source 501 and the value of i (the value stored in entry 551 in the RRF read array 550 that sub-circuit 500 is associated with). Comparator 511 may further receive as input a signal 571 indicating whether the received instruction is a FXCH instruction, e.g., based on the op-code of the received instruction. If signal 571 indicates that the received instruction is a FXCH instruction, and if the value of logical source 501 is equal to the value of i stored in entry 551, then comparator 511 may output a signal 541 indicating that a swap is required (e.g., a signal representing a value of one), e.g., indicating that it is required to write the value of logical destination 502 in entry 551 of RRF read array 550. In contrast, if signal 571 indicates that the received instruction is not a FXCH instruction, and/or if the value of logical source 501 is different from the value of i, then comparator 511 may output a signal indicating that a swap is not required (e.g., a signal representing a value of zero) with regard to the content i of entry 551 of the RRF read array 550.

Similarly, a comparator 512 may compare between the value of the logical destination 502 and the value of i (the value stored in entry 551 in the RRF read array 550 that sub-circuit 500 is associated with). Comparator 512 may further receive as input a signal 572 indicating whether the received instruction is a FXCH instruction, e.g., based on the op-code of the received instruction. If signal 572 indicates that the received instruction is a FXCH instruction, and if the value of logical destination 502 is equal to the value of i stored in entry 551, then comparator 512 may output a signal 542 indicating that a swap is required (e.g., a signal representing a value of one), e.g., indicating that it is required to write the value of logical source 501 in entry 551 of RRF read array 550. In contrast, if signal 572 indicates that the received instruction is not a FXCH instruction, and/or if the value of logical destination 502 is different from the value of i, then comparator 512 may output a signal indicating that a swap is not required (e.g., a signal representing a value of zero) with regard to the content i of entry 551 of the RRF read array 550.

Signals 541 and 542 may be used as selection inputs for a multiplexer 520, which may further receive as data input the value of the logical source (denoted 501A) and the value of the logical destination (denoted 502A). Multiplexer 520 may output a signal 530 based on the received signals 541 and 542. For example, if both signals 541 and 542 indicate a value of zero, then output signal 530 may indicate that no modification is required to the content i of entry 551 of RRF read array 550. If signal 541 indicates a value of one, then output signal 530 may indicate that it is required to modify the content i of entry 551 to the value of logical destination 502A and the modification may be performed, for example, by a logic unit of the RRF. If signal 542 indicates a value of one, then output signal 530 may indicate that it is required to modify the content i of entry 551 to the value of logical source 501A, and the modification may be performed, for example, by a logic unit of the RRF.

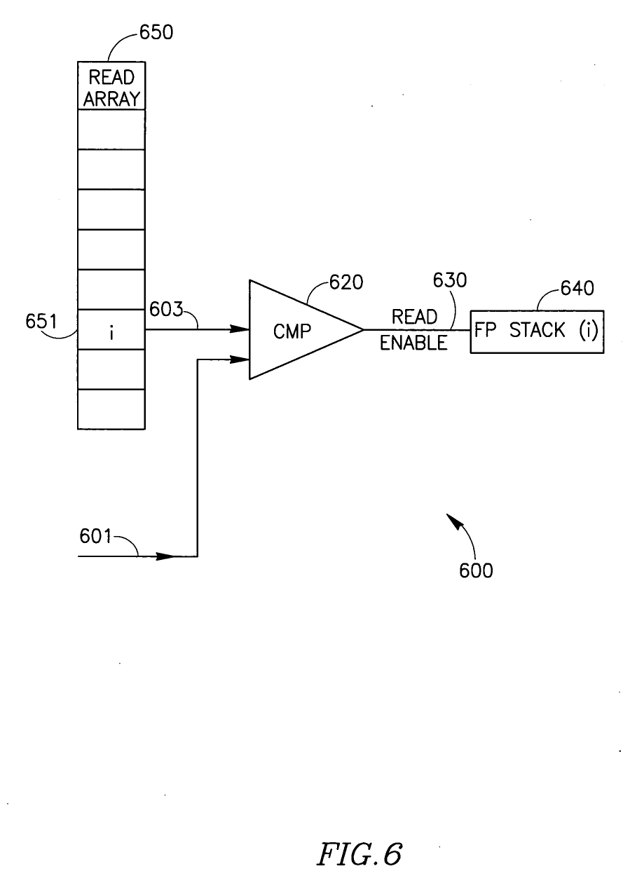

FIG. 6 schematically illustrates a RRF sub-circuit 600 able to perform a read stage in accordance with some embodiments of the invention. Sub-circuit 600 may be, for example, part of RRF 300 of FIG. 1, part of RRF 400 of FIG. 4, or part of other RRF units.

In some embodiments, the RRF may include multiple sub-circuits similar to sub-circuit 600 which may correspond to multiple entries in a RRF read array 650, respectively. For example, the RRF may include a first sub-circuit 600 associated with a first entry in the RRF read array 650, a second sub-circuit 606 associated with a second entry in the RRF read array 650, etc. In the demonstrative example of FIG. 6, sub-circuit 600 is associated with an entry 651 of the RRF read array 650; entry 651 may store a value, denoted i, which may point to a FP register. For example, initially, the value i may point to the ith physical FP register; subsequently, e.g., after one or more FXCH instructions are executed, the value i may be modified to point to another physical FP register.

In some embodiments, in order to read data from a FP register, the RAT may send to the ROB an address of a FP register, indicated as signal 601. A comparator 620 may compare between the value received from the RAT (represented by signal 601) and the value i of entry 651 of the RRF read array 650 (represented by a signal 603) which may point to a certain physical FP register. If the comparison result is positive, then comparator 620 may output a signal 630 indicating to enable a read operation from the FP register to which entry 651 points, e.g., FP register 640 located at ST(i); the value read from that FP register 640 may be sent to the RS. In contrast, if the comparison result is negative, then the content of the FP register 640 to which entry 651 points may not be read. It is noted that in some embodiments, when the value I is carried by signal 603, one comparator out of multiple comparators associated with multiple FP registers, respectively, may yield a positive comparison result.

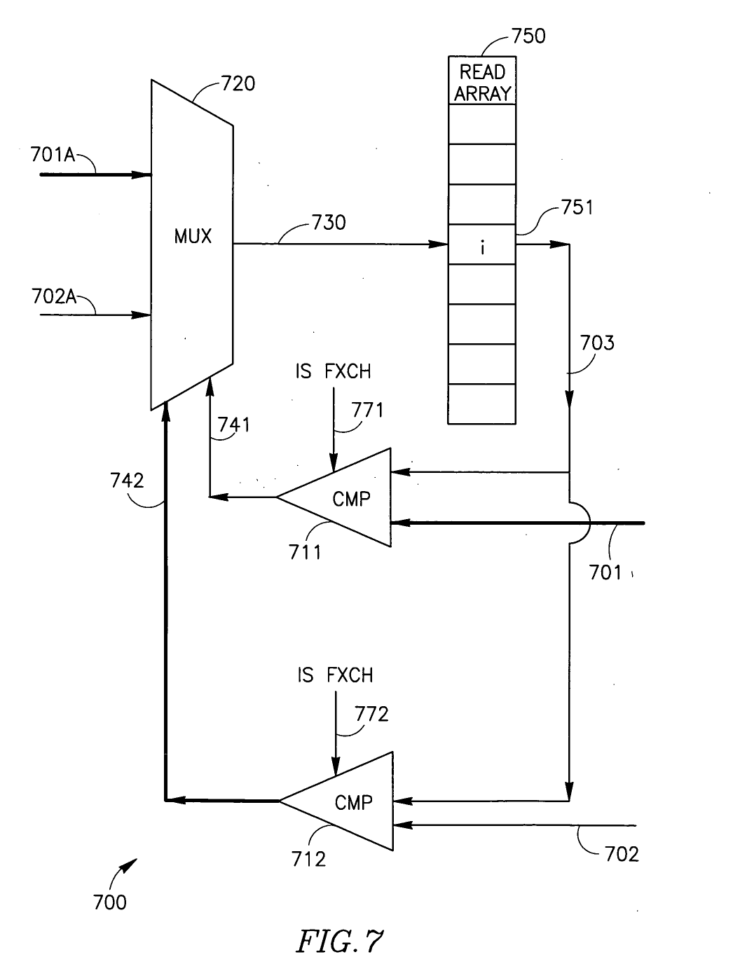

FIG. 7 schematically illustrates a RRF sub-circuit 700 able to perform a retirement stage in accordance with some embodiments of the invention. Sub-circuit 700 may be, for example, part of RRF 300 of FIG. 1, part of RRF 400 of FIG. 4, or part of other RRF units.

In some embodiments, upon retirement, or when it is certain that a micro-operation will retire, the ROB may receive a logical source and a logical destination, and the RRF may swap between these two values in a RRF write array 750. For example, the RRF may compare the value of the logical source and the value, denoted i, of an entry 751 of the RRF write array 750; if the values are equal, and the received instruction is a FXCH instruction, then the RRF may write the value of the logical destination into the entry 751 of the RRF write array 750. Similarly, for example, the RRF may compare the value of the logical destination and the value of entry 751 of the RRF write array 750; if the values are equal, and the received instruction is a FXCH instruction, then the RRF may write the value of the logical source into entry 751 of the RRF write array 750.

In some embodiments, the RRF may include multiple sub-circuits similar to sub-circuit 700 which may correspond to multiple entries in the RRF write array 750, respectively. For example, the RRF may include a first sub-circuit 700 associated with a first entry in the RRF write array 750, a second sub-circuit 700 associated with a second entry in the RRF write array 750, etc.

In some embodiments, an instruction having one or more operands, for example, a logical source 701 and a logical destination 702, may be received by the RRF sub-circuit 700. sub-circuit 700 may be one of multiple sub-circuits that correspond to entries in RRF write array 750, respectively. For example, sub-circuit 700 may be associated with an entry 751 in the RRF write array 750, and entry 751 may store an index value which may be denoted i, the index value pointing to a FP register of the RRF. The index value i stored in entry 751 may be represented or indicated using a signal 703. For example, initially, the value i may point to the ith physical FP register; subsequently, e.g., after one or more FXCH instructions are executed, the value i may be modified to point to another physical FP register.

A comparator 711 may compare between the value of the logical source 701 and the value of i (the value stored in entry 751 of the RRF write array 750 that sub-circuit 700 is associated with). Comparator 711 may further receive as input a signal 771 indicating whether the received instruction is a FXCH instruction, e.g., based on the op-code of the received instruction. If signal 771 indicates that the received instruction is a FXCH instruction, and if the value of logical source 701 is equal to the value of i stored in entry 751, then comparator 711 may output a signal 741 indicating that a swap is required (e.g., a signal representing a value of one), e.g., indicating that it is required to write the value of logical destination 702 in entry 751 of RRF write array 750. In contrast, if signal 771 indicates that the received instruction is not a FXCH instruction, and/or if the value of logical source 701 is different from the value of i, then comparator 711 may output a signal indicating that a swap is not required (e.g., a signal representing a value of zero) with regard to the content i of entry 751 of the RRF write array 750.

Similarly, a comparator 712 may compare between the value of the logical destination 702 and the value of i (the value stored in entry 751 of the RRF write array 750 that sub-circuit 700 is associated with). Comparator 712 may further receive as input a signal 772 indicating whether the received instruction is a FXCH instruction, e.g., based on the op-code of the received instruction. If signal 772 indicates that the received instruction is a FXCH instruction, and if the value of logical destination 702 is equal to the value of i stored in entry 751, then comparator 712 may output a signal 742 indicating that a swap is required (e.g., a signal representing a value of one), e.g., indicating that it is required to write the value of logical source 701 in entry 751 of RRF write array 750. In contrast, if signal 772 indicates that the received instruction is not a FXCH instruction, and/or if the value of logical destination 702 is different from the value of i, then comparator 712 may output a signal indicating that a swap is not required (e.g., a signal representing a value of zero) with regard to the content i of entry 751 of the RRF read array 750.

Signals 741 and 742 may be used as selection inputs for a multiplexer 720, which may further receive as data input the value of the logical source (denoted 701A) and the value of the logical destination (denoted 702A). Multiplexer 720 may output a signal 730 based on the received signals 741 and 742. For example, if both signals 741 and 742 indicate a value of zero, then output signal 730 may indicate that no modification is required to the content i of entry 751 of RRF write array 750. If signal 741 indicates a value of one, then output signal 730 may indicate that it is required to modify the content i of entry 751 to the value of logical destination 702A, and the modification may be performed, for example, by a logic unit of the RRF. If signal 742 indicates a value of one, then output signal 730 may indicate that it is required to modify the content i of entry 751 to the value of logical source 701A, and the modification may be performed, for example, by a logic unit of the RRF.

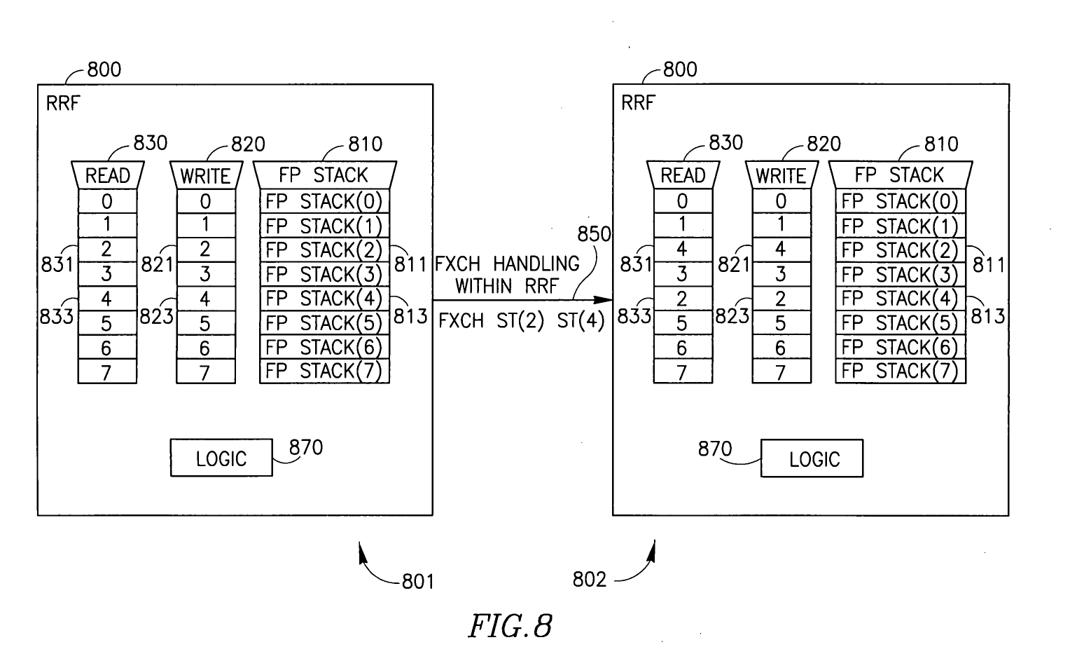

FIG. 8 schematically illustrates a RRF 800 retirement stage functionality in accordance with some embodiments of the invention. Portion 801 demonstrates the content of RRF 800 prior to handling a FXCH instruction, and portion 802 demonstrates the content of RRF 800 subsequent to handling the FXCH instruction. The RRF 800 may include, for example, a FP registers stack 810, e.g., having eight FP registers; a RRF write array 820, e.g., having eight records corresponding to the eight FP registers of stack 810; a RRF read array 830, e.g., having eight records corresponding to the eight FP registers of stack 810; and a RRF logic unit 870.

As indicated at portion 801, prior to handling a FXCH instruction, the content of a record 831 in RRF read array 830 may point to a FP register 813, and the content of a record 821 in RRF write array 820 may point to a FP register 811. Similarly, the content of a record 833 in RRF read array 830 may point to FP register 811, and the content of a record 823 in RRF write array 820 may point to FP register 813.

As indicated by arrow 850, the FXCH instruction may be handled internally by the RRF 800, e.g., utilizing the RRF logic unit 870 instead of by an external component, e.g., a RAT unit. For example, the FXCH instruction may require swapping between the content of FP register 811 and the content of FP register 813.

As indicated at portion 802, upon handling the FXCH instruction, the content of record 821 may be swapped with the content of record 823. This may be performed, for example, utilizing RRF logic unit 870 of RRF 800. For example, subsequent to executing the FXCH instruction, the content of record 821 in RRF write array 820 may point to FP register 813, instead of pointing to FP register 811; and the content of record 823 in RRF write array 820 may point to FP register 81 1; instead of pointing to FP register 813.

In some embodiments, for example, the FXCH instruction may affect only writing to FP registers, and may not affect reading from the FP registers, or vice versa. Accordingly, for example, the content of records 821 and 823 of RRF write array 820 may be swapped, whereas the content of records 831 and 833 of RRF read array 830 may be maintained unmodified (e.g., not swapped), or vice versa, respectively. In the demonstrative example shown in portion 802 of FIG. 8, a FXCH instruction, e.g., the instruction “FXCH ST(2) ST(4)”, may result in swapping between contents of records in the RRF write array 820, e.g., upon retirement or if it is certain that the micro-operation will retire.

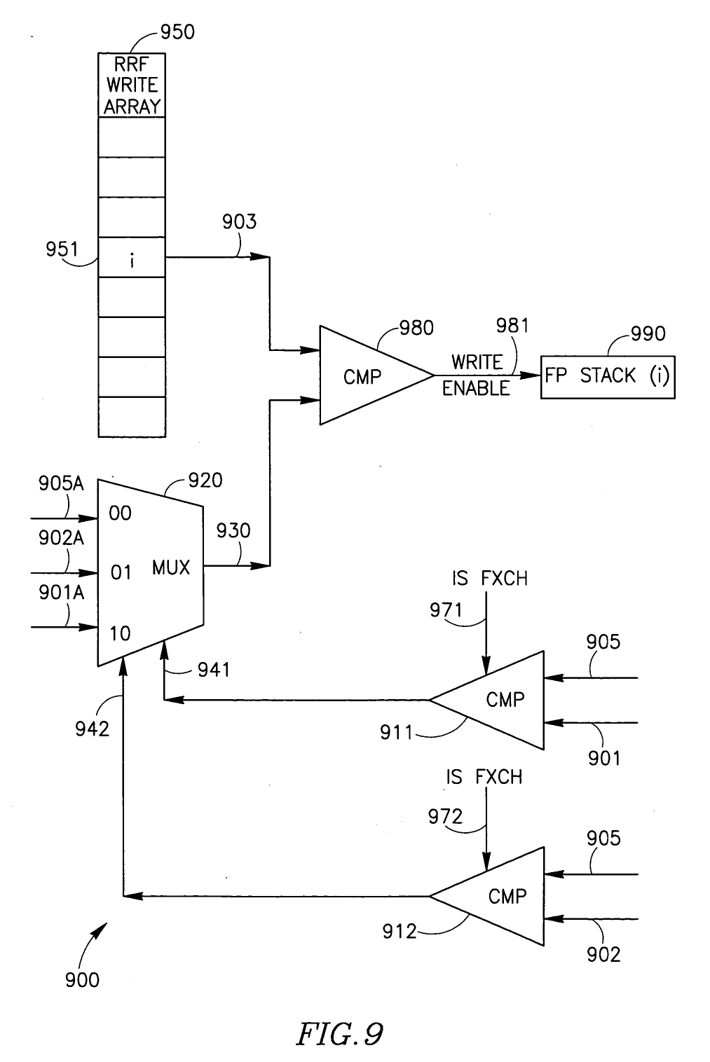

FIG. 9 schematically illustrates a RRF sub-circuit 900 able to handle retirement of FP micro-operations in accordance with some embodiments of the invention. Sub-circuit 900 may be, for example, part of RRF 300 of FIG. 1, part of RRF 400 of FIG. 4, or part of other RRF units.

In some embodiments, not more than one FXCH instructions may be processed and/or retired within a clock cycle. For example, in one embodiment, multiple micro-operations (e.g., four micro-operations) may retire during a retirement window of a clock cycle. If a FXCH instruction is included in the retiring instructions, then the FXCH instruction may occupy a first retirement slot (e.g., denoted retirement slot 0) in the retirement window of that clock cycle; and another instruction (e.g., non FXCH instruction) may occupy another, non-first, retirement slot (e.g., denoted retirement slot k). This order may, for example, avoid contradicting results between a read instruction and a FXCH instruction which may attempt to retire within a retirement window of a single clock cycle.

For example, a first entry in a RRF write array may store the value “0”, pointing to the first (e.g., the top) FP register in the FP registers stack; and a second entry in the RRF write array may store the value “1”, pointing to the second FP register in the FP registers stack. The retirement window may include a first retirement slot, occupied by the instruction “FXCH ST(0) ST(1)”; and a second retirement slot, occupied by the instruction “FADD X Y ST(0)”. The FXCH instruction pending in the first retirement slot may retire first, resulting in a swap between the content of the first and second entries in the RRF write array, such that the first entry in the RRF write array may store the value “0” and the second entry in the RRF write array may store the value “1”. Then, when the FADD instruction retires, the results of the FADD instruction are stored in the second FP register (and not in the first FP register), since the entry in the RRF write array that stores the value “0” (namely, the second entry of the RRF write array) points to the second FP register.

In some embodiments, for example, a comparator 911 may receive as input a value of a logical destination 905 from retirement slot k, and a value of a logical source 901 from retirement slot 0. Comparator 911 may further receive as input a signal 971 indicating whether or not retirement slot 0 is occupied by a FXCH instruction, e.g., based on the op-code of the instruction in retirement slot 0.

Similarly, a comparator 912 may receive as input the value of the logical destination 905 from retirement slot k, and a value of a logical destination 902 from retirement slot 0. Comparator 912 may further receive as input a signal 972 indicating whether or not retirement slot 0 is occupied by a FXCH instruction, e.g., based on the op-code of the instruction in retirement slot 0.

If signals 971 and 972 indicate that the instruction at retirement slot 0 is not a FXCH instruction, then comparator 911 may output a signal 941 having a value of zero, and comparator 912 may output a signal 942 having a value of zero. Signals 941 and 942 may be used as selection inputs for a multiplexer 920, which may further receive as data input the value of the logical source the logical destination from retirement slot k (denoted 905A), the value of the logical destination from retirement slot 0 (denoted 902A), and the value of the logical source from retirement slot 0 (denoted 901A). If the values represented by signals 941 and 942 are equal to zero, then multiplexer 920 may output a signal 930 representing the value of the logical destination 905A of retirement slot k.

In contrast, signals 971 and 972 may indicate that the instruction at retirement slot 0 is a FXCH instruction. If the value of the logical destination 905 from retirement slot k is equal to the value of the logical source 901 from retirement slot 0, and the instruction at retirement slot 0 is a FXCH instruction, then comparator 911 may output the signal 941 having a value of one. Alternatively, if the value of the logical destination 905 from retirement slot k is not equal to the value of the logical source 901 from retirement slot 0, and the instruction at retirement slot 0 is a FXCH instruction, then comparator 911 may output the signal 941 having a value of zero.

Similarly, if the value of the logical destination 905 from retirement slot k is equal to the value of the logical destination 902 from retirement slot 0, and the instruction at retirement slot 0 is a FXCH instruction, then comparator 912 may output the signal 942 having a value of one. Alternatively, if the value of the logical destination 905 from retirement slot k is not equal to the value of the logical destination 902 from retirement slot 0, and the instruction at retirement slot 0 is a FXCH instruction, then comparator 912 may output the signal 942 having a value of zero.

If signal 941 represents a value of one, or if signal 942 represents a value of one, then multiplexer 920 may output the signal 930 representing a swapped value. For example, if the value of the logical destination 905 from retirement slot k is equal to the value of the logical source 901 from retirement slot 0, and the instruction at retirement slot 0 is a FXCH instruction, then comparator 911 may output the signal 941 having a value of one, and multiplexer 920 may output the value of the logical destination 902A from retirement slot 0. Alternatively, if the value of the logical destination 905 from retirement slot k is equal to the value of the logical destination 902 from retirement slot 0, and the instruction at retirement slot 0 is a FXCH instruction, then comparator 912 may output the signal 942 having a value of one, and multiplexer 920 may output the value of the logical source 901A from retirement slot 0.

The value of output 930 of multiplexer 920 may be compared, using a comparator 980, to a value, which may be denoted i and carried by a signal 903, of an entry 951 of a RRF write array 950, the value i pointing to a certain physical FP register. If the comparison result is positive, then comparator 981 may output a signal 981 to enable a write into a FP register 990 indicated by the content i of entry. 951. In contrast, if the comparison result is negative, then comparator 981 may not output the write enabling signal.

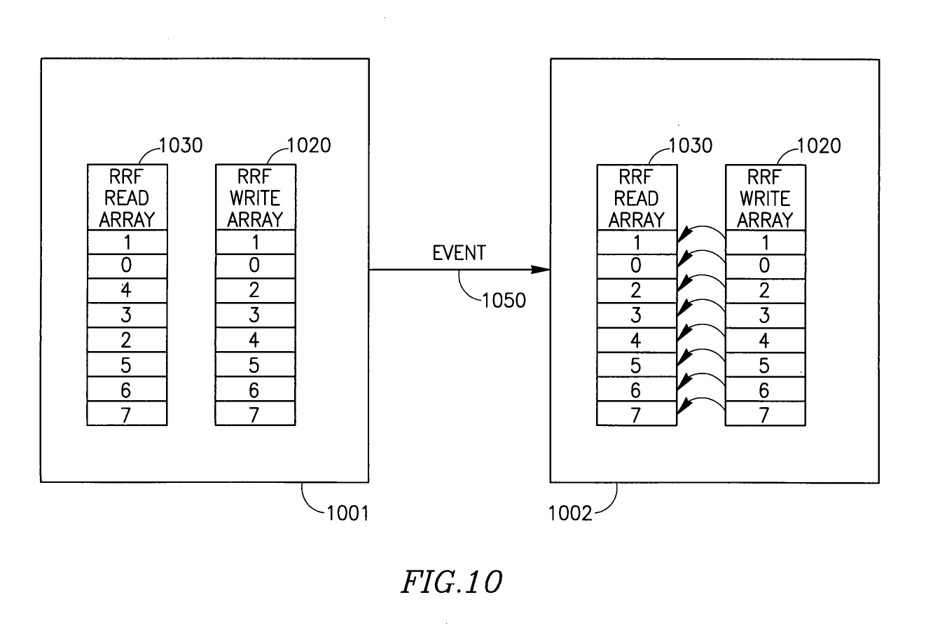

FIG. 10 schematically illustrates a RRF recovery stage functionality in accordance with some embodiments of the invention. Portion 1001 demonstrates the content of a RRF read array 1030 and the content of a RRF write array 1020 prior to recovery, for example, from an event which requires recovery, e.g., a division by zero. The content of the RRF read array 1030 may be speculative, whereas the content of the RRF write array may be correct.

As indicated by arrow 1050, an event which requires recovery may be detected, e.g., by ROB retirement logic. Portion 1002 demonstrates the content of the RRF read array 1030 and the content of the RRF write array 1020 after the recovery. For example, the content of the entries of the RRF write array 1020 may be copied into the respective entries of the RRF read array 1030.

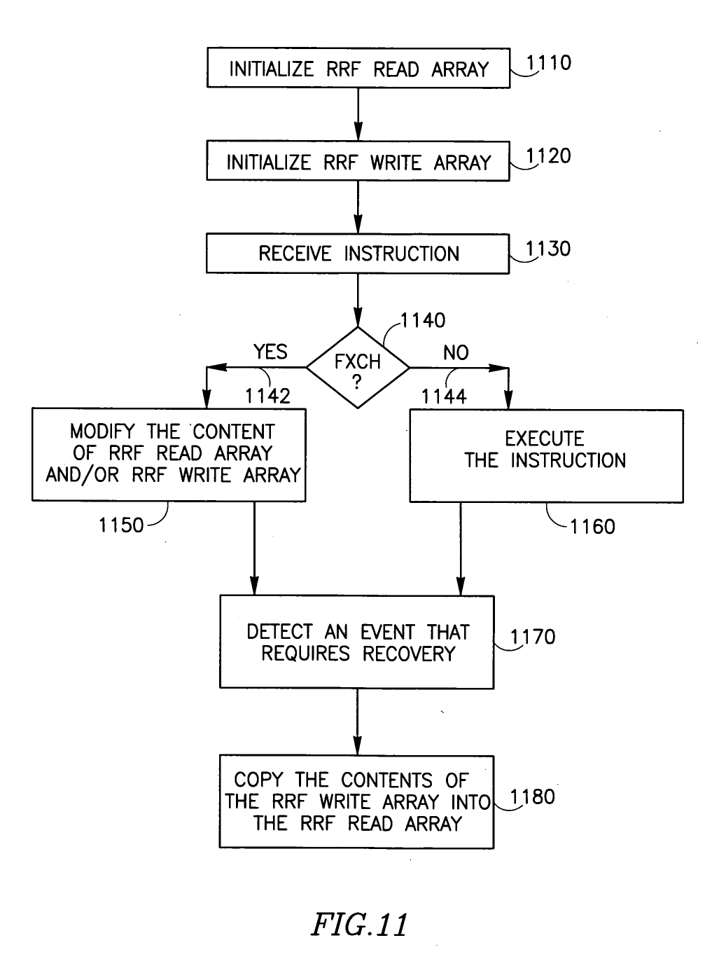

FIG. 11 is a schematic flow-chart of a method of handling FXCH instructions in accordance with an embodiment of the invention. Operations of the method may be implemented, for example, by RRF 390 of FIG. 3, by processor core 300 of FIG. 3, and/or by other suitable RRF units, processor cores, processors, components, devices, and/or systems.

As indicated at box 1110, the method may optionally include, for example, initializing a RRF read array having entries corresponding to FP registers. This may include, for example, resetting the content of the RRF read array, e.g., such that the content of the first entry of the RRF read array points to the first FP register, the content of the second entry of the RRF read array points to the second FP register, etc.

As indicated at box 1120, the method may optionally include, for example, initializing a RRF write array having entries corresponding to the FP registers. This may include, for example, resetting the content of the RRF write array, e.g., such that the content of the first entry of the RRF write array points to the first FP register, the content of the second entry of the RRF write array points to the second FP register, etc.

As indicated at box 1130, the method may optionally include, for example, receiving an instruction intended for execution. For example, the instruction may be sent by a RAT to the RRF, substantially without modification by the RAT. The instruction may include an op-code and one or more operands, e.g., a source operand and a destination operand.

As indicated at box 1140, the method may optionally include, for example, determining whether the received instruction is a FXCH instruction. This may be performed, for example, based on the op-code of the received instruction.

As indicated by arrow box 1142, if the determination result is positive, then the method may optionally include, as indicated at box 1150, modifying the content of one or more entries in the RRF read array and/or the RRF write array. This may include, for example, swapping between the content of a first entry of the RRF read array and the content of a second entry of the RRF read array; and/or swapping between the content of a first entry of the RRF write array and the content of a second entry of the RRF write array.

Conversely, as indicated by arrow 1144, if the determination result is positive, then the method may optionally include, as indicated at box 1160, executing the instruction, e.g., while maintaining the content of the RRF read array and the RRF write array substantially unmodified.

As indicated at box 1170, the method may optionally include, for example, detecting an event which requires a recovery.

As indicated at box 1180, the method may optionally include, for example, copying the content of the entries of the RRF write array into the corresponding entries of the RRF read array, respectively.

Other suitable operations or sets of operations may be used in accordance with embodiments of the invention. In some embodiments, for example, the method may include: receiving from a register alias table an unmodified FXCH micro-instruction indicating an exchange between two FP registers of a RRF; receiving from a RAT an unmodified FP micro-instruction that requires access to a FP register of the RRF; and, based on the FXCH micro-instruction, modifying an operand of the FP micro-instruction.

Some embodiments of the invention may be implemented by software, by hardware, or by any combination of software and/or hardware as may be suitable for specific applications or in accordance with specific design requirements. Embodiments of the invention may include units and/or sub-units, which may be separate of each other or combined together, in whole or in part, and may be implemented using specific, multi-purpose or general processors or controllers, or devices as are known in the art. Some embodiments of the invention may include buffers, registers, stacks, storage units and/or memory units, for temporary or long-term storage of data or in order to facilitate the operation of a specific embodiment.

Some embodiments of the invention may be implemented, for example, using a machine-readable medium or article which may store an instruction or a set of instructions that, if executed by a machine, for example, by processor cores 300, by other suitable machines, cause the machine to perform a method and/or operations in accordance with embodiments of the invention. Such machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit (e.g., memory unit 135 or 202), memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Re-Writeable (CD-RW), optical disk, magnetic media, various types of Digital Versatile Disks (DVDs), a tape, a cassette, or the like. The instructions may include any suitable type of code, for example, source code, compiled code, interpreted code, executable code, static code, dynamic code, or the like, and may be implemented using any suitable high-level, low-level, object-oriented visual, compiled and/or interpreted programming language, e.g., C, C++, Java, BASIC, Pascal, Fortran, Cobol, assembly language, machine code, or the like.

While certain features of the invention have been illustrated and described herein, many modifications, substitutions, changes, and equivalents may occur to those skilled in the art. It is, therefore, to be understood that the appended claims are intended to cover all such modifications and changes as fall within the true spirit of the invention.

What is claim is:

1. An apparatus comprising:
a real register file unit able to perform a floating point exchange micro-instruction.

2. The apparatus of claim 1, wherein the real register file unit is to modify an operand of a floating point micro-instruction that attempts to access a floating point register of said real register file unit, if said operand requires modification based on the floating point exchange micro-instruction.

3. The apparatus of claim 2, wherein the real register file unit comprises:
a read array to store logical pointers for reading from physical floating point registers of said real register file unit.

4. The apparatus of claim 3, wherein the real register file unit comprises:
a write array to store logical pointers for writing to the physical floating point registers of said real register file unit.

5. The apparatus of claim 4, wherein the real register file unit comprises:
a logic unit to determine whether a received micro-instruction is a floating point exchange micro-instruction that affects an access of the floating point micro-instruction to said floating point register of said real register file unit.

6. The apparatus of claim 5, wherein the logic unit is to modify a content of one or more entries of the read array if the floating point exchange micro-instruction affects a subsequent micro-instruction that attempts to perform a read access to said floating point register of said real register file unit.

7. The apparatus of claim 5, wherein the logic unit is to modify a content of one or more entries of the write array if the received floating point exchange micro-instruction affects a subsequent micro-instruction that attempts a write access to said floating point register of said real register file unit.

8. The apparatus of claim 5, wherein the logic unit is to swap, in response to the floating point exchange micro-instruction, between a content of a first entry of the read array and a content of a second entry of the read array.

9. The apparatus of claim 5, wherein the logic unit is to swap, in response to the floating point exchange micro-instruction, between a content of a first entry of the read array and a content of a second entry of the write array.

10. The apparatus of claim 5, wherein the logic unit is to copy, upon recovery, the contents of the entries of the write array into the corresponding entries of the read array, respectively.

11. The apparatus of claim 5, wherein the logic unit is to place said floating point exchange micro-instruction as a single floating point exchange micro-instruction within a retirement window associated with a single clock cycle.

12. The apparatus of claim 11, wherein the logic unit is to place said floating point exchange micro instruction in a first retirement slot of said retirement window.

13. The apparatus of claim 1, further comprising:
an instructions decoder to decode said floating point exchange micro-instruction and said floating point micro-instruction; and
a register alias table to identify said floating point exchange micro-instruction and said floating point micro-instruction, and to transfer said floating point exchange micro-instruction and said floating point micro-instruction substantially unmodified to said real register file unit.

14. A system comprising:
a memory unit to store instructions intended for execution by a processor core; and
a real register file unit of said processor core able to perform a floating point exchange micro-instruction.

15. The system of claim 14, wherein the real register file unit is to modify an operand of a floating point micro-instruction that attempts to access a floating point register of said real register file unit, if said operand requires modification based on the floating point exchange micro-instruction.

16. The system of claim 15, wherein the real register file unit comprises:
a read array to store logical pointers for reading from physical floating point registers of said real register file unit; and
a write array to store logical pointers for writing to the physical floating point registers of said real register file unit.

17. The system of claim 16, wherein the real register file unit comprises:
a logic unit to determine whether a received micro-instruction is a floating point exchange micro-instruction that affects an access of the floating point micro-instruction to said floating point register of said real register file unit.

18. The system of claim 17, wherein the logic unit is to modify a content of one or more entries of the read array if the floating point exchange micro-instruction affects a subsequent micro-instruction that attempts to perform a read access to said floating point register of said real register file unit.

19. The system of claim 17, wherein the logic unit is to modify a content of one or more entries of the write array if the received floating point exchange micro-instruction affects a subsequent micro-instruction that attempts a write access to said floating point register of said real register file unit.

20. The system of claim 17, wherein the logic unit is to swap, in response to the floating point exchange micro-instruction, between a content of a first entry of the read array and a content of a second entry of the read array.

21. The system of claim 17, wherein the logic unit is to swap, in response to the floating point exchange micro-instruction, between a content of a first entry of the write array and a content of a second entry of the write array.

22. A method comprising:
receiving from a register alias table an unmodified floating point exchange micro-instruction indicating an exchange between two floating point registers of a real register file unit;
receiving from a register alias table an unmodified floating point micro-instruction that requires access to a floating point register of said real register file unit; and
based on the floating point exchange micro-instruction, modifying an operand of said floating point micro-instruction.

23. The method of claim 22, wherein modifying comprises:
modifying a content of one or more entries of a read array of said real register file unit if the floating point exchange micro-instruction affects the floating point micro-instruction that attempts to perform a read access to said floating point register of said real register file unit.

24. The method of claim 23, wherein modifying a content comprises:
swapping between a content of a first entry of the read array of said real register file unit and a content of a second entry of the read array of said real register file unit.

25. The method of claim 22, wherein modifying comprises:
modifying a content of one or more entries of a write array of said real register file unit if the floating point exchange micro-instruction affects the floating point micro-instruction that attempts to perform a write access to said floating point register of said real register file unit.

26. The method of claim 25, wherein modifying a content comprises:
swapping between a content of a first entry of the write array of said real register file unit and a content of a second entry of the write array of said real register file unit.
